(19) United States
(12) Patent Application Publication
(10) Pub. No.: US 2013/0162471 A1
(43) Pub. Date: Jun. 27, 2013

(54) POSITIONING SUPPORT DEVICE AND POSITIONING SUPPORT METHOD

(71) Applicants: Takashi Suzuki, Chiyoda-ku (JP); Tomoharu Aoki, Chiyoda-ku (JP); Miho Kikkawa, Chiyoda-ku (JP)

(72) Inventors: Takashi Suzuki, Chiyoda-ku (JP); Tomoharu Aoki, Chiyoda-ku (JP); Miho Kikkawa, Chiyoda-ku (JP)

(73) Assignee: NTT DOCOMO, INC., Tokyo (JP)

(21) Appl. No.: 13/820,658

(22) PCT Filed: Jul. 9, 2012
(86) PCT No.: PCT/JP2012/067479

§ 371 Date: Mar. 4, 2013

(30) Foreign Application Priority Data
Jul. 12, 2011 (JP) 2011-154154

(51) Int. Cl. G01S 19/06

(52) U.S. Cl. CPC G01S 19/06
USPC 342/357.43

(57) ABSTRACT

Provided is a positioning support device that provides approximate location information including more appropriate error radius information. With a positioning method (positioning support method) by a positioning support system 10 and a positioning system 1 including the positioning support system 10, it is determined in a SUPL server 20 whether an error radius included in location information (approximate location information) of a base station device 70 acquired from a mobile communication network N2 that is another communication network falls within a prescribed range. If out of the prescribed range, the error radius is updated to a predetermined value, and approximate location information including the updated error radius information is thereafter transmitted to a mobile station 60 for positioning computation. This makes it possible to provide approximate location information including more appropriate error radius information for positioning computation.

### TECHNICAL FIELD

The present invention relates to a positioning support device that transmits approximate location information used as assist data during positioning computation by a mobile station, and to a positioning support method by the positioning support device.

### BACKGROUND ART

With enhanced performance of mobile stations such as mobile phones, mobile stations having a positioning function using a GNSS (Global Navigation Satellite System) become popular. When positioning computation using the GNSS is performed in a mobile station, with a stand-alone positioning system in which positioning is performed by receiving radio waves only from GNSS satellites, there are concerns about the longer positioning time and the increase in power consumption in a mobile station. Therefore, a network-assisted system is adopted which is intended to reduce a positioning time by transmitting capture information (assist data) such as the locations of GNSS satellites from a positioning support server to a mobile station. In the network-assisted GNSS positioning, as information indicating a rough location of a mobile station (approximate location information), information for specifying a central location (for example, a location where a base station is provided) of a communication area in which the mobile station is present, and an error radius of the communication area are transmitted as one of assist data from the positioning support server to the mobile station (for example, see Patent Literature 1).

### CITATION LIST

### Patent Literature

Patent Literature 1: Japanese Patent Application Laid-Open Publication No. 2008-175824

### SUMMARY OF INVENTION

### Technical Problem

Here, when information indicating the location of a base station is created and provided by the network of the carrier of the mobile station, the accuracy of the information can be managed by the carrier's network. However, when a base station where the mobile station exists does not belong to the carrier's network, for example, as in the case of roaming out to an overseas mobile communication network, it is not possible to grasp approximate location information. In such a case, it is possible to manage rough general location information by learning from a positioning result. However, in this case, the accuracy becomes lower than that of information managed on the other network side. General location information may be acquired from the other network side. In this case, if general location information is correctly managed on the other network side, the accuracy of the general location information is higher than when learning is performed. However, the accuracy of the approximate location information cannot be confirmed on the carrier side that receives the approximate location information. Therefore, if error radius information of a communication area that is included in approximate location information provided by the other carrier is significantly smaller than the expected communication area, the location where the mobile station actually exists may fall out of the communication area indicated by the approximate location information, resulting in failure in positioning. By contrast, if error radius information is significantly larger than the expected communication area, the communication area specified with the approximate location information becomes larger, and the accuracy as approximate location information is presumably reduced. When the error radius information included in approximate location information does not have a proper value in this manner, the rate of success in positioning by a mobile station may be reduced.

The present invention is made in view of the foregoing and aims to provide a positioning support device capable of providing approximate location information including more appropriate error radius information, and a positioning support method by the positioning support device.

### Solution to Problem

In order to solve the object above, a positioning support device according to an embodiment of the present invention is used for positioning computation when a mobile station in another communication network different from the network of the carrier of the mobile station captures satellites and performs positioning using information from the satellites, and transmits approximate location information including error radius information that is information indicating an error radius of an area in which the mobile station is located. The positioning support device includes approximate location information acquisition means for acquiring the approximate location information from the other communication network, error radius information update means for updating the error radius information included in the approximate location information acquired by the approximate location information acquisition means, and approximate location information transmission means for transmitting the approximate location information updated by the error radius information update means. The error radius information update means determines whether the error radius falls within a prescribed range, and, if the error radius falls out of the prescribed range, updates the error radius information with a value different from the error radius specified with the error radius information as a new error radius.

A positioning support method according to an embodiment of the present invention is performed by a positioning support device that is used for positioning computation when a mobile station in another communication network different from the network of the carrier of the mobile station captures satellites and performs positioning using information from the satellites, and transmits approximate location information including error radius information that is information indicating an error radius of an area in which the mobile station is located. The positioning support method includes an approximate location information acquisition step of using approximate location information acquisition means to acquire the approximate location information from the other communication network, an error radius information update step of using error radius information update means to update the error radius information included in the approximate location information acquired in the approximate location information acquisition step, and an approximate location information transmission step of using approximate location information transmission means to transmit the approximate location information updated in the error radius information update step. In the error radius information update step, whether the error radius falls within a prescribed range is determined, and, if the error radius falls out of the prescribed range, the error radius information is updated with a value different from the error radius specified with the error radius information as a new error radius.

In the positioning support method and the positioning support system as described above, it is determined whether an error radius specified with the error radius information included in the approximate location information acquired from the other communication network falls within a prescribed range. If it falls out of the prescribed range, the error radius is updated with a value different from the error radius acquired from the other communication network, and thereafter approximate location information including the updated error radius information is transmitted for positioning computation. This makes it possible to provide approximate location information including more appropriate error radius information.

Here, the positioning support device may further include positioning result reception means for receiving positioning result information that is information transmitted from a destination to which the approximate location information is transmitted by the approximate location information transmission means and indicating a result of the positioning computation. The error radius information update means may decide a numerical range for determining whether update of the error radius information is required, based on the positioning result information received by the positioning result reception means.

With the configuration described above, the positioning support device acquires the positioning result information resulting from transmission of the approximate location information, and a numerical range for determining whether update of the error radius information is required is decided based on the positioning result. Therefore, a more appropriate numerical range of an error radius is selected as a criterion for determining whether update is required. As a result, it becomes possible to provide approximate location information including more appropriate error radius information.

Here in order to effectively achieve the effect above, specifically, the positioning result information may include information indicating whether the positioning by the mobile station is successful and information indicating the number of satellites captured by the mobile station. The error radius information update means may hold a prescribed first range and a prescribed second range having a value smaller than the first range, in advance. When the positioning by the mobile station is successful or when the number of satellites captured by the mobile station is equal to or greater than a prescribed number, whether update is required may be determined based on whether the error radius of the communication area is included in the first range. When the positioning by the mobile station is failed and when the number of satellites captured by the mobile station is smaller than the prescribed number, whether update is required may be determined based on whether the error radius of the communication area is included in the second range.

In this manner, two kinds of numerical ranges are held in advance, and whether update of the error radius is required is determined by selecting from the two kinds of numerical ranges depending on whether the positioning by the mobile station is successful and the number of satellites captured by the mobile station. Accordingly, it becomes possible to provide approximate location information including more appropriate error radius information.

The positioning support device may further include environmental information reception means for receiving environmental information indicating an environment surrounding the mobile station. Based on a range corresponding to the environmental information received by the environmental information reception means, the error radius information update means may determine whether the error radius falls within the range.

In this manner, whether update of the error radius is required is determined by deciding a numerical range for determining whether update is required in accordance with the environment surrounding the mobile station that is included in the environmental information. Accordingly, it becomes possible to provide approximate location information including more appropriate error radius information.

The positioning support device may include approximate location information storage means for storing the approximate location information, positioning result reception means for receiving positioning result information that is information transmitted from a destination to which the approximate location information is transmitted by the approximate location information transmission means and indicating a result of the positioning computation, and approximate location information update means for updating error radius information included in the approximate location information stored in the approximate location information storage means, based on the positioning result information, and for setting the updated error radius information as learned error radius information. The error radius information update means may set the prescribed range based on the learned error radius information.

With the configuration above, the error radius information can be updated using the learned error radius specified with the learned error radius information included in the approximate location information held in the positioning support device and updated in accordance with the past positioning result. This makes it possible to provide approximate location information including more appropriate error radius information in accordance with the past positioning result.

Here, in order to effectively achieve the effect above, specifically, the error radius information update means may determine whether an error radius specified with the error radius information included in the approximate location information acquired by the approximate location information acquisition means is greater than a learned error radius specified with the learned error radius information updated by the approximate location information update means, and, if the error radius is smaller than the learned error radius, update the error radius information with the learned error radius as a new error radius in place of the error radius specified with the error radius information.

In this manner, whether update of the error radius information is required is determined depending on whether the error radius information included in the approximate location information acquired by the approximate location information acquisition means is greater than the learned error radius, and, as a result, if update is required, the error radius information is updated with the learned error radius as a new error radius. Accordingly, the learned error radius information updated based on the past positioning result can be used effectively to provide approximate location information including more appropriate error radius information.

### Advantageous Effects of Invention

The present invention provides a positioning support device capable of providing approximate location information including more appropriate error radius information, and a positioning support method by the positioning support device.

### BRIEF DESCRIPTION OF DRAWINGS

FIG. 1 is a block diagram illustrating a configuration of a communication system according to an embodiment of the present invention.

FIG. 2 is a diagram showing a hardware configuration of each device, an ISP, and a GW included in a positioning support system 2.

FIG. 3 is a diagram showing a hardware configuration of a mobile station.

FIG. 4 shows an example of approximate location information stored in an approximate location information DB.

FIG. 5 shows an example of location information of an SGSN that is stored in the approximate location information DB.

FIG. 6 shows an example of information stored in a management DB.

FIG. 7 is a sequence diagram illustrating a process for performing communication between a mobile station and an SUPL server.

FIG. 8 is a sequence diagram illustrating a process of authenticating a mobile station and a process concerning preparation of approximate location information to be transmitted to the mobile station in a mobile communication network.

FIG. 9 is a sequence diagram illustrating a process, in the SUPL server, concerning update of error radius information.

FIG. 10 is a sequence diagram illustrating a process concerning GNSS positioning in a mobile station and a process after the positioning.

FIG. 11 is a sequence diagram illustrating a process, in the SUPL server, of determining whether a base station is an indoor station or an outdoor station.

FIG. 12 is a sequence diagram illustrating a process, in the SUPL server, concerning update of error radius information.

### DESCRIPTION OF EMBODIMENTS

In the following, embodiments of the present invention will be described in details with reference to the accompanying drawings. It is noted that, in the description of the drawings, the same elements are denoted with the same reference signs, and an overlapping description will be omitted.

<Configuration of Positioning Support System>

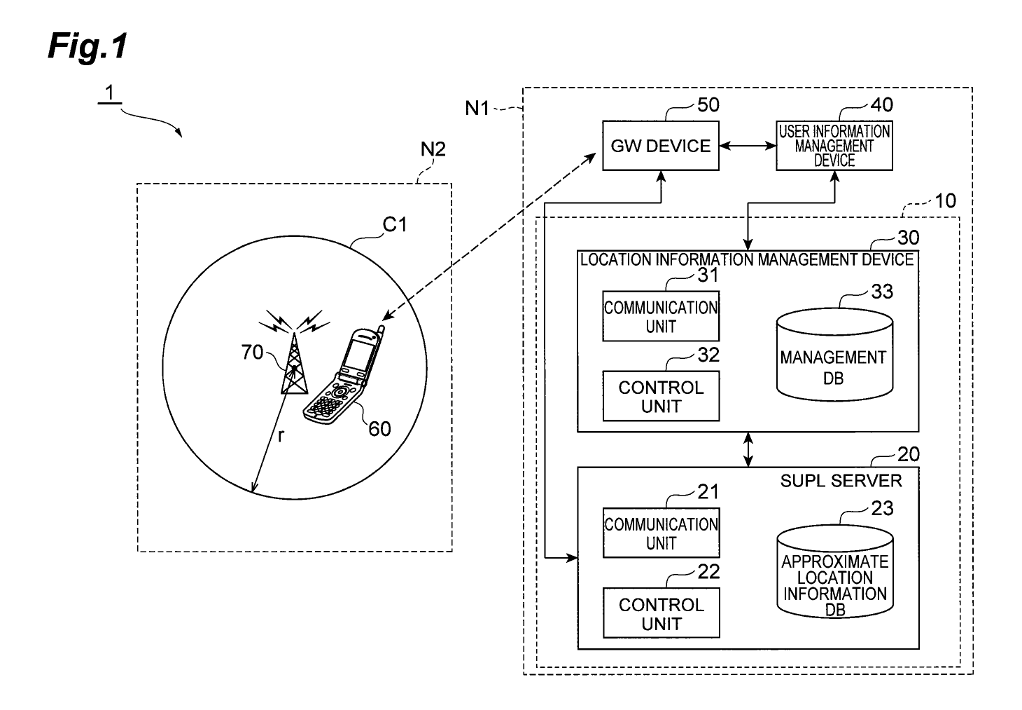

FIG. 1 is a block diagram illustrating a configuration of a positioning system 1 according to an embodiment of the present invention. The positioning system 1 is configured to include an SUPL (Secure User Plane Location) server 20 and a location information management device 30, which constitute a positioning support system 10, a user information management device 40, a GW (Gateway) device 50, a mobile station 60, and a base station device 70. Among those, the positioning support system 10 constituted with the SUPL server 20 and the location information management device 30 is a device that supports positioning computation by the mobile station 60, and the user information management device 40, the GW device 50, and the base station device 70 each are a device concerning communication between the mobile station 60 and the positioning support system 10. The SUPL server 20, the location information management device 30, the user information management device 40, and the GW device 50 are devices included in the same mobile communication network, and the mobile station 60 has a function of connecting to the mobile communication network N1. In the present embodiment, the mobile station 60 is in a state of roaming out of the mobile communication network N1, for example, as in the case of overseas use, and performs communication by connecting to the base station device 70 included in a mobile communication network N2 different from the mobile communication network N1. Here, a case where the mobile station 60 performs positioning by receiving assist data from the positioning support system 10 included in the mobile communication network N1 is described.

Here, a positioning method performed by the mobile station 60 in the present embodiment is described. In the present embodiment, the positioning method performed by the mobile station 60 is network-assisted GNSS (Global Navigation Satellite System) positioning. GNSS positioning is a method of receiving signals from three or more GNSS satellites in the sky and thereby calculating the location (specifically, latitude, longitude, and altitude) of a receiver terminal (mobile station 60) based on location information of the GNSS satellites. In order to do so, the GNSS satellites have to be captured by the mobile station 60, and this process takes a certain time. Therefore, in the network-assisted GNSS positioning according to the present embodiment, information (assist data) such as the locations of GNSS satellites and information of the approximate location (initial location) of the mobile station 60 is transmitted from the positioning support system 10 to the mobile station, whereby the time required for the process concerning the capturing of GNSS satellites by the mobile station 60 and for the positioning is reduced. In the present embodiment, the mobile station 60 requests provision of assist data from the positioning support system 10 and then receives from the positioning support system 10 information indicating the approximate location of the mobile station 60 and the location information of GNSS satellites from which the mobile station 60 can receive signals, whereby the GNSS positioning is performed in the mobile station 60 to find the location of the mobile station 60.

Of the assist data sent from the positioning support system 10 to the mobile station 60, for the location information of the GNSS satellites, information acquired from an assist data provider (not shown) that manages GNSS satellite starting information in the positioning support system 10 is used. For the approximate location information of the mobile station 60, location information of a base station device that transmits radio waves to a cell (communication area) in which the mobile station 60 is present is used. This is because the location of the base station device is predetermined, and the location information of the base station device can be stored in the positioning support system 10 in advance and can be transmitted to the mobile station 60 when information that specifies a cell in which the mobile station 60 is present is transmitted from the mobile station 60, based on the information that specifies a cell.

In a case where the base station device described above is provided by the mobile communication network N1 (that is, the base station device is included in the mobile communication network N1), the location information of the base station device can be easily obtained, so that it is easy to store the location information as assist data in the positioning support system 10. However, as in the present embodiment, when the mobile station 60 has roamed out, it is difficult for the positioning support system 10 to grasp the precise information of the location where the base station device 70 is provided because the base station device 70 where the mobile station 60 is present is provided by another mobile communication network N2. Therefore, if the approximate location information is created based on the information provided from the mobile station 60 (for example, information that specifies a country where the mobile station is present or a telecommunications carrier providing the mobile communication network N2), the accuracy of the approximate location information is significantly reduced, so that the accuracy of the result of the GNSS positioning performed using this information is reduced. In the embodiment described below, the positioning system 1 including the positioning support system 10 with the enhanced accuracy of the approximate location information to be transmitted to the mobile station 60 will be described.

Here, each device included in the positioning system 1 is described. First, the SUPL server 20 that constitutes the positioning support system 10 included in the positioning system 1 is a device having a main function of the positioning support system 10 and has a function of storing assist data to be transmitted to the mobile station 60 and transmitting the assist data to the mobile station 60 based on a request from the mobile station 60.

The location information management device 30 that constitutes the positioning support system 10 together with the SUPL server 20, has a function of performing an authentication process for performing communication for positioning with the mobile station 60, additionally has a function as a GMLC (Gateway Mobile Location Center) for managing data concerning location information in the mobile communication network N1, and is implemented as an EBSCP (External Bussinessuser Service Control Point). Specifically, for example, profile data of a communication network (including the mobile communication network N2) different from the network of the carrier of the mobile station (the mobile communication network N1) is stored and transmitted to the SUPL server 20 as necessary. The detailed processing according to the present embodiment will be described later.

The user information management device 40 has a function of storing information (user profile) concerning the owner (user) of the mobile station that performs communication for positioning with the positioning support system 10, and is implemented, for example, as an SUSCP (Specific User Service Control Point). Then, this information is provided in response to a request from the location information management device 30.

The GW device 50 is provided between the mobile communication network N1 and a mobile communication network (for example, the mobile communication network N2) different therefrom, has a function of connecting the mobile communication network N2 and the mobile communication network N1 with each other, and is implemented, for example, as a CPCG (Charging and Protocol Conversion Gateway). A mobile station that has roamed out like the mobile station 60 has to connect to the GW device 50 in the first place in order to perform communication with each device included in the mobile communication network N1. The GW device 50 mediates communication between the mobile station 60 that has transmitted a connection request from an external mobile communication network, and each device (in the present embodiment, the SUPL server 20) included in the mobile communication network N1.

The mobile station 60 is used by a user and is specifically implemented, for example, as a device having a communication function, such as a mobile phone or a PDA (Personal Digital Assistance). The mobile station 60 according to the present embodiment has a function concerning roaming to allow communication using a facility (for example, the base station device 70) provided by another carrier and thereby having a function of performing communication via the mobile communication network N2. In addition, the mobile station 60 has a function of performing GNSS positioning using assist data from the positioning support system 10.

The base station device 70 is a device included in the mobile communication network N2 and forms a cell C1 by transmitting radio waves to a particular range. When the mobile station 60 is within the cell C1, the mobile station 60 can perform communication by transmitting/receiving information through the base station device 70. A unique cell ID is allocated to each cell, and which base station device 70 is related to a cell can be identified with this cell ID. The base station device 70 is managed by an SGSN (Serving GPRS Support Node) (not shown) located upstream (upper level) of the base station device in the mobile communication network N2 for performing control of packet communication. In the other words, the SGSN is involved in control of packet communication in the area (upper-level area) that covers the cell C1 formed by the base station device 70.

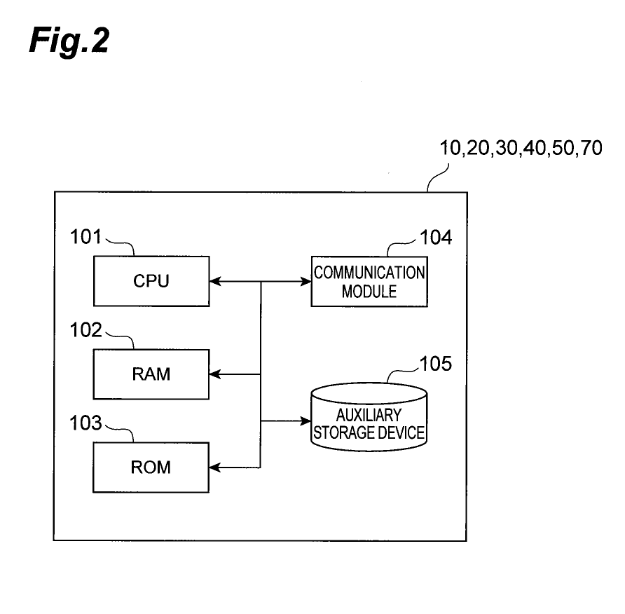

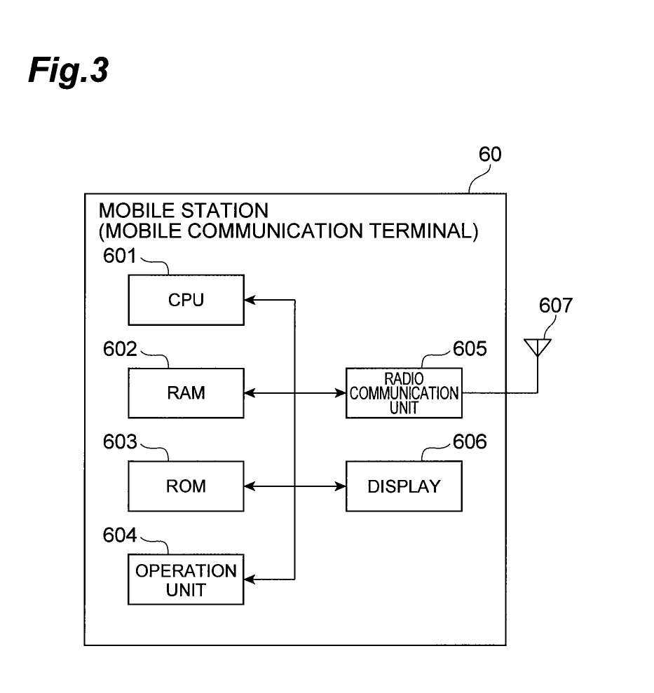

Each of the SUPL server 20, the location information management device 30, the user information management device 40, the GW device 50, and the base station device 70 included in the positioning system 1 is configured as a computer including hardware such as a CPU 101, a RAM (Random Access Memory) 102 and a ROM (Read Only Memory) 103 as main storages, a communication module 104 for performing communication, and an auxiliary storage device 105 such as a hard disk, as shown in FIG. 2. These components operate to fulfill the function of each device. The mobile station 60 is configured with hardware such as a CPU (Central Processing Unit) 601, a RAM 602, a ROM 603, an operation unit 604, a radio communication unit 605, a display 606, and an antenna 607, as shown in FIG. 3. These components operate to fulfill the function of the mobile station 60.

Connections are established, through a wired network, between the SUPL server 20 and the location information management device 30, between the location information management device 30 and the user information management device 40, between the user information management device 40 and the GW device 50, and between the GW device 50 and the SUPL server 20. Information is exchanged, through radio communications, between the mobile station 60 and the GW device 50 and between the mobile station 60 and the base station device 70.

With reference back to FIG. 1, the SUPL server 20 and the location information management device 30 included in the positioning support system 10, which is the positioning support device included in the positioning system 1 and characterizing the present invention, is described in detail. The SUPL server 20 is configured to include a communication unit (approximate location information acquisition means, approximate location information transmission means, positioning result reception means, environmental information reception means) 21, a control unit (error radius information update means, approximate location information transmission means) 22, and an approximate location information DB (database) (approximate location information storage means) 23. The location information management device 30 is configured to include a communication unit 31, a control unit (approximate location information acquisition means, approximate location information transmission means) 32, and a management DB 33.

The communication unit 21 of the SUPL server 20 receives a positioning information transmission request transmitted from the mobile station 60. The communication unit 21 has a function as approximate location information acquisition means for acquiring approximate location information of a communication area in which the mobile station 60 is present, from the mobile communication network N2, based on this positioning information transmission request. The communication unit 21 additionally functions as approximate location information transmission means for transmitting assist data including approximate location information to the mobile station 60. The communication unit 21 also has a function as positioning result reception means for receiving a positioning result transmitted from the mobile station 60. The communication unit 21 further has a function of transmitting/receiving information to/from the location information management device 30. The information received by the communication unit 21 is sent to the control unit 22.

The control unit 22 has a function of acquiring information stored in the approximate location information DB 23, based on the positioning information transmission request transmitted from the mobile station 60. The approximate location information to be transmitted by the control unit 22 to the mobile station 60 is decided also based on information transmitted by the location information management device 30 described later, for the purpose of transmitting more accurate approximate location information to the mobile station 60. The specific processing thereof will be described in the description concerning a positioning support method described later.

The control unit 22 also has a function as approximate location information update means for updating approximate location information stored in the approximate location information DB 23 described later, based on positioning result information indicating the result of GNSS positioning that is transmitted from the mobile station 60. The update of approximate location information by the control unit 22 is not limited to overwrite of approximate location information in a case where the mobile station 60 is successful in GNSS positioning, but includes initialization of approximate location information in a case where the GNSS positioning is failed and the approximate location information is determined as being error. The procedure of update of approximate location information by the control unit 22 will be described later.

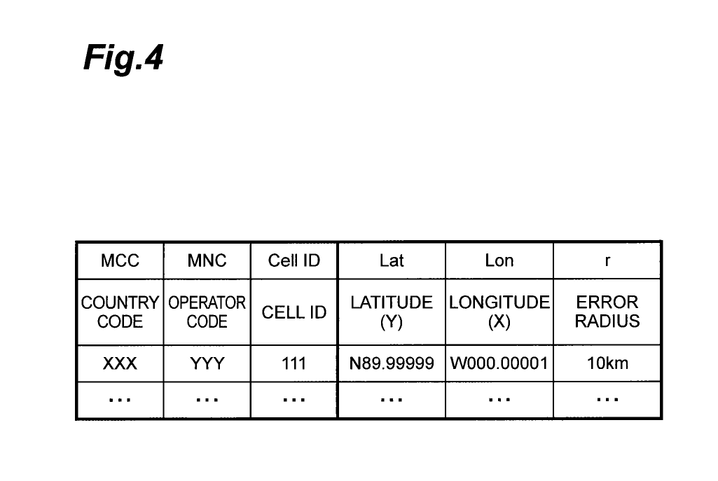

The approximate location information DB 23 functions as approximate location information storage means in which information of the base station related to the cell is stored in association with the cell ID of the cell. FIG. 4 shows an example of approximate location information stored in the approximate location information DB 23. Of the information shown in FIG. 4, an MCC (Mobile Country Code, country code), an MNC (Mobile Network Code, operator code (for example, set for each carrier)), and a cell ID are predetermined. The positioning information transmission request transmitted from the mobile station 60 also includes the MCC, MNC, and cell ID as described above, as information that specifies the cell in which the mobile station 60 is present. Lat (Latitude (Y)), Lon (Longitude (X)), and r (error radius) are associated with the cell ID and stored in the approximate location information DB 23. The latitude and the longitude are information indicating the location of the base station device 70 provided at the center of the cell C1 in the example shown in FIG. 1. The error radius indicates the size (dimensions) of the cell associated with the cell ID and corresponds to the radius r of the cell C1 shown in FIG. 1.

As shown in FIG. 4, the approximate location information stored in association with the cell ID is not information precisely indicating the location of the base station device but is information updated (learned) based on the result of positioning in the same cell in the past. A variety of learning methods can be used. For example, there is a method in which a midpoint between a location specified with approximate location information used by the mobile station 60 to perform positioning and a location specified with the positioning result by the mobile station 60 is calculated, and the resultant location is set as a new location of the cell C1 in which the mobile station 60 performed positioning. In this case, for example, the maximum value of the distance between the new center and the location specified with the positioning result by the mobile station successful in positioning using the approximate location information concerning the cell C1 in the past, from the center of the cell C1 specified with latitude and longitude, is set as an updated error radius (learned error radius information).

In addition to the information stored in the approximate location information DB 23 based on the past positioning result as described above, the approximate location information provided to the mobile station 60 by the SUPL server 20 may be acquired by making an inquiry to the GMLC of the other carrier that manages the base station device (in the present embodiment, the mobile communication network N2) with the cell ID designated corresponding to the base station device. In this case, more precise location information more related to the communication area can be provided because the other carrier grasps the precise location information of the base station device.

However, the information indicating the location of the base station device that is acquired from the GMLC of the other carrier cannot be managed by the carrier that forms the carrier's network (in the present embodiment, the mobile communication network N1). Therefore, for example, when information concerning the error radius of the cell C1 that is included in the approximate location information provided by the other carrier is significantly smaller than the expected communication area, the mobile station 60 may fall out of the cell C1 specified with the approximate location information, and the positioning may be failed. On the other hand, the error radius included in the location information acquired from the other carrier may be significantly larger or significantly smaller than a precise value expected to be set. When the information concerning the error radius is significantly larger than the expected communication area, the communication area specified with the approximate location information is greater, and the accuracy as approximate location information may be possibly reduced. When the error radius information included in the approximate location information does not have an appropriate value in this manner, the rate of success in positioning by the mobile station may be reduced. In the present embodiment, the process performed in the SUPL server 20 in order to prevent the phenomenon as described above is described, although the details thereof will be described later.

The information stored in the approximate location information DB 23 includes the latitude, longitude, and error radius described above and, in addition, information indicating uncertainty (accuracy) in the altitude and height direction. A flag indicating whether provision of approximate location information is possible may be associated with the approximate location information and stored in the approximate location information DB 23. In this case, for example, when the approximate location information is not precise enough, for example, when the number of times of updates is small, a flag indicating that provision is impossible is set. Then, if this flag indicating that provision is impossible is set, it is determined that the use of this approximate location information is not permitted, and the acquisition of the approximate location information by the control unit 32 described later is stopped.

It is noted that the approximate location information associated with the cell ID is not stored in advance in the approximate location information DB 23 when the location of the base station device is not precisely known and when positioning is not performed in the past in the cell having the same cell ID. In this case, the location information obtained from the MCC and the MNC transmitted from the mobile station 60 is used as approximate location information to be transmitted to the mobile station 60. This information is transmitted by the location information management device 30 described later, which process will be described later.

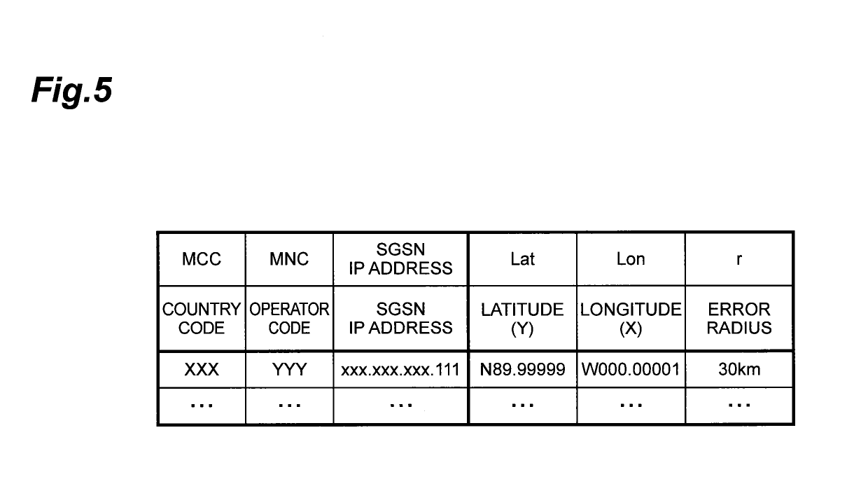

FIG. 5 shows an example of approximate location information of an SGSN that is stored in the approximate location information DB 23, similarly. As described above, the SGSN is a device that manages a plurality of base station devices, and the positioning information transmission request transmitted from the mobile station 60 includes the SGSN's IP (Internet Protocol) address for specifying the SGSN that manages the base station device 70 to which the mobile station 60 connects. Therefore, if the location information of the SGSN is known while the location of the base station device 70 is unknown, this information can also be used as approximate location information.

Since a plurality of base station devices are under the management of the SGSN, it is necessary to cover a range wider than a cell managed by a single base station device. Therefore, the approximate location information of the SGSN has an error radius set larger when compared with the approximate location information of a cell. In other words, the error radius (error information) concerning latitude and longitude is appropriately changed in accordance with a region in which it is assumed that approximate location information should be used. For the reason above, the error radius of the approximate location information of the SGSN is presumably larger than the approximate location information of a cell. On the other hand, if the approximate location information of the SGSN is calculated to include a wrong positioning result and the like, an error radius completely different from an error radius estimated by the general SGSN function is derived. If this value is used as an error radius, it becomes difficult to appropriately use the approximate location information, and the accuracy of the positioning result by the mobile station 60 may be significantly reduced. Therefore, it is possible to preset the minimum value and the maximum value for the error radius.

The information shown in FIG. 5 is stored when being transmitted from the location information management device 30 described later to be used in GNSS positioning. It is noted that the “location information of the SGSN” in the following description refers to the central location (reference location) of the area (upper-level area) that contains a plurality of cells including the cell C1 formed by the base station device 70 shown in FIG. 1, and does not always indicate the location where the SGSN is installed. In other words, the location of the SGSN refers to a location serving as the center of a communication area constituted with base stations under the SGSN.

A flag indicating whether provision of the approximate location information of the SGSN is possible may be associated with the approximate location information of the SGSN and stored in the approximate location information DB 23. In this case, for example, when the approximate location information is not precise enough, for example, when the number of times of updates is small, the flag indicating that provision is impossible is set. Then, if this flag indicating that provision is impossible is set, it is determined that the use of this approximate location information is not permitted, and the acquisition of the approximate location information by the control unit 32 described later is stopped.

Next, with reference back to FIG. 1, the location information management device 30 included in the positioning support system 10 is described. The communication unit 31 of the location information management device 30 has a function of performing a process of authenticating the mobile station 60 that transmits a connection request to the SUPL server 20 by performing communication with the user information management device 40, and a function of transmitting location information (the location information specified with MCC and MNC, the location information of the SGSN, etc.) stored in the location information management device 30 to the SUPL server 20 by performing communication with the SUPL server 20.

The control unit 32 has a function of performing an authentication process for the mobile station 60 based on a request from the SUPL server 20 and also has a function as part of the approximate location information transmission means for deciding approximate location information to be transmitted to the mobile station 60. The information that is included in the approximate location information transmission request transmitted from the mobile station 60 and is transmitted from the SUPL server 20 to the location information management device 30 includes the MCC, MNC, and cell ID described above as information (roaming area information) concerning the cell in which the mobile station 60 is present. Similarly, information (the IP address of the SGSN) that specifies the SGSN controlling the base station device 70 related to the cell in which the mobile station 60 is present is also included. In the control unit 32, based on these pieces of information, determination is made as to (1) whether information that specifies the location of the base station device 70 can be obtained, and (2) whether the location of the SGSN controlling the base station device 70 is held in the location information management device 30. Then, based on this determination result, information concerning decision of approximate location information to be transmitted from the control unit 32 to the SUPL server 20 is selected and transmitted to the SUPL server 20. The details of the determination above and the process based on the determination result will be described later.

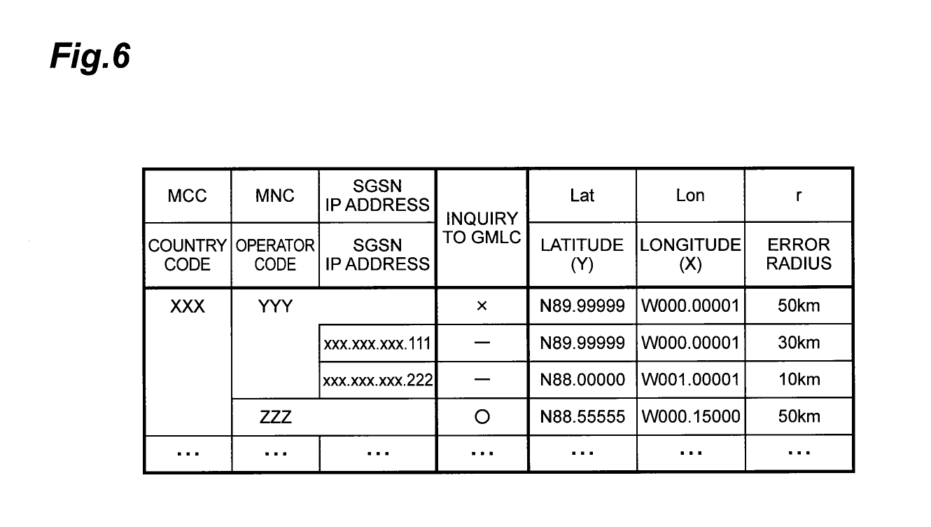

The management DB 33 functions as part of the approximate location information storage means for storing information concerning decision of approximate location information to be transmitted to the mobile station 60. An example of the information stored in the management DB 33 is shown in FIG. 6. The MCC and MNC, the IP address of the SGSN, and the location information (latitude, longitude, error information) are associated with each other and stored in the management DB 33. The location information described above associated with the MCC and the MNC and stored is also included. Of the information (the information shown in FIG. 6) stored in the management DB 33, the location information stored in association with the IP address of the SGSN is precise information that is based on, for example, information transmitted by the operator specified with the MCC and the MNC. In a case where the location information of the SGSN is not disclosed, as is the case with an operator (carrier) specified with the MNC “ZZZ,” the location information provisionally obtained from the MCC and the MNC (for example, the location information indicating the location of the headquarters of the operator) is stored. In this manner, the approximate location information obtained using at least part of the MCC, the MNC, and the IP address of the SGSN is stored in the management DB 33.

Furthermore, a flag indicating “whether an inquiry to the GMLC is possible” that is associated with the MCC and the MNC is given to each piece of information stored in the management DB 33. This is a flag indicating whether an inquiry about the location information of the base station device corresponding to the cell ID can be made from the location information management device 30 to the GMLC of the operator. When a flag indicating “inquiry possible” to the GMLC of a particular operator is given, precise location information of the base station device can be obtained by making an inquiry about the location of the base station device using the cell ID from the location information management device 30 to the GMLC of the operator. Whether an inquiry to the GMLC is possible is decided, for example, by making an agreement in advance between the carrier providing the mobile communication network N1 and the operator as the other party.

The information stored in the management DB 33 of the location information management device 30 is stored in advance by the carrier providing the mobile communication network N1. In the control unit 32 of the location information management device 30, which information is to be transmitted to the SUPL server 20 is determined based on the information stored in the management DB 33 described above, and appropriate information is transmitted to the SUPL server 20 based on the result thereof.

In the positioning system 1 according to the present invention, each device functions as described above, whereby approximate location information is transmitted to the mobile station 60 in response to a request from the mobile station 60, and the approximate location information is updated based on the GNSS positioning result by the mobile station 60.

In the embodiment below, a description will be given of a case where the mobile station 60 is in the mobile communication network N2 provided by the carrier that can make an inquiry to the GMLC, such as the operator (carrier) specified with the MNC “ZZZ” in FIG. 6.

<Positioning Method (Positioning Support Method) by Positioning System Including Positioning Support System>

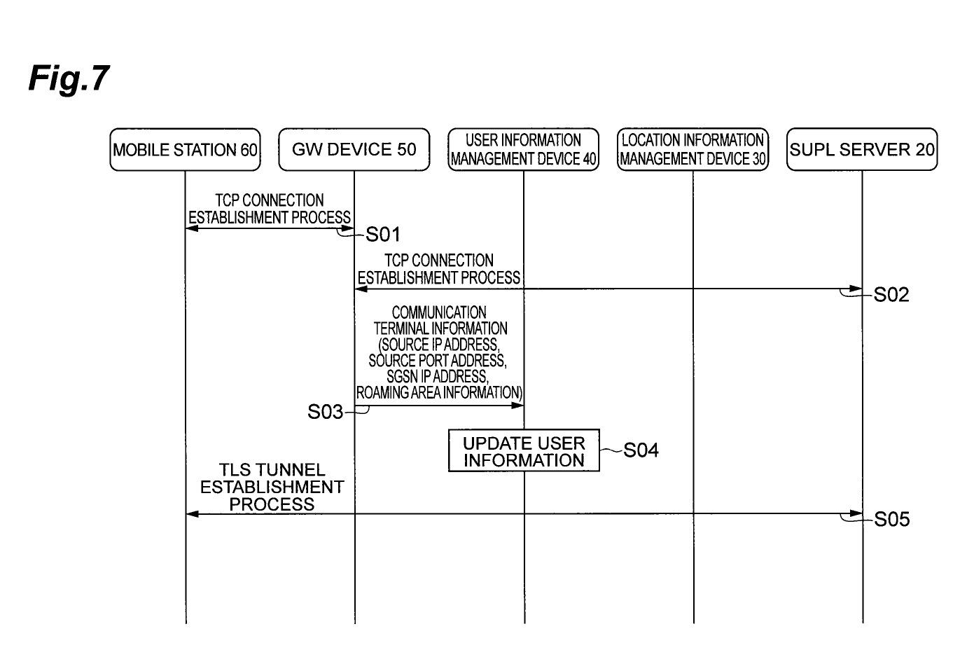

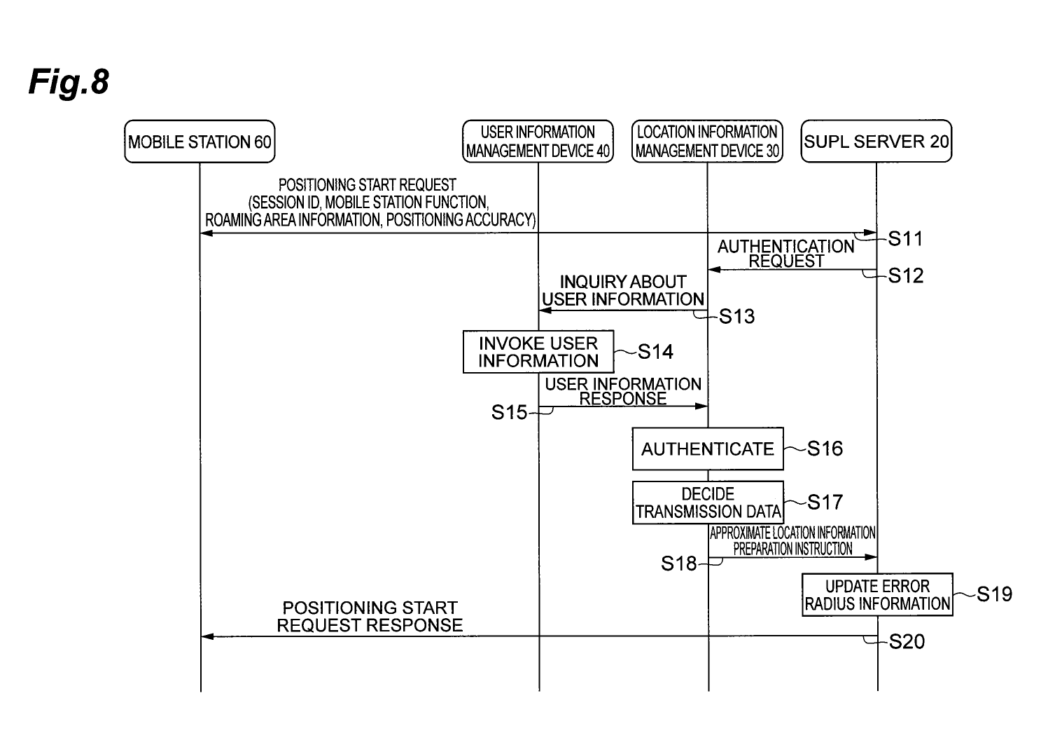

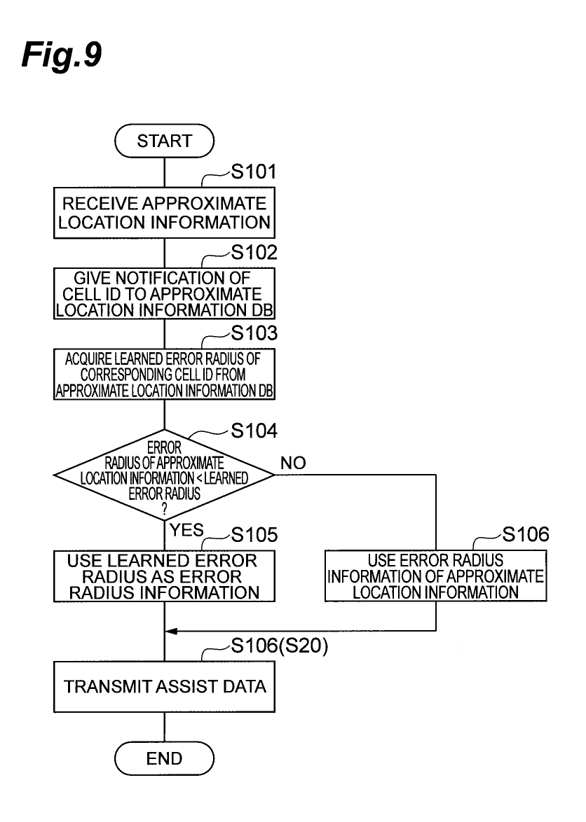

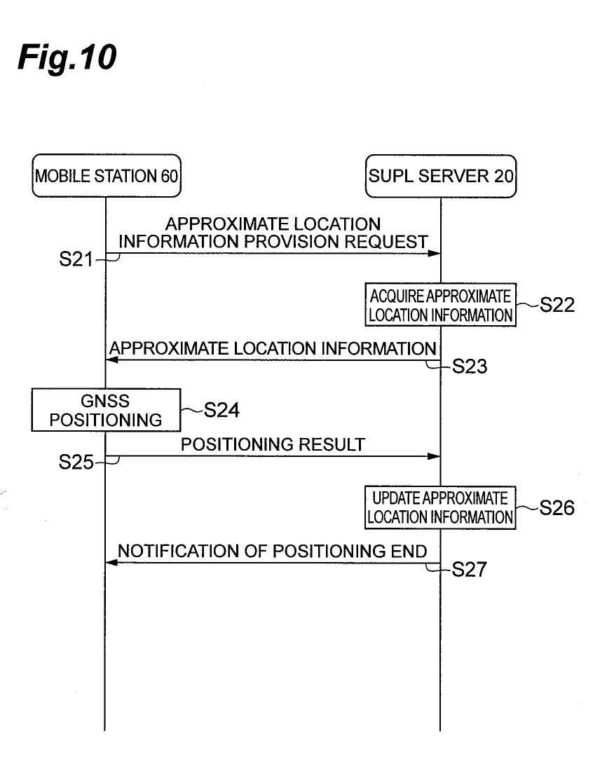

Next, a positioning method by the positioning system 1 including the positioning support system 10 as described above (the positioning support method by the positioning support system 10) will be described with reference to the sequence diagrams shown in FIG. 7, FIG. 8, and FIG. 10 and the flowchart shown in FIG. 9. FIG. 7 is a sequence diagram illustrating a process for performing communication between the mobile station 60 and the SUPL server 20. FIG. 8 is a sequence diagram illustrating a process of authenticating the mobile station 60 and a process concerning preparation of approximate location information to be transmitted to the mobile station 60 in the mobile communication network N1. FIG. 10 is a sequence diagram illustrating a process concerning GNSS positioning in the mobile station 60 and a process after the positioning. FIG. 9 is a flowchart illustrating the details of the process shown in FIG. 8.

First, referring to FIG. 7, a process for performing communication between the mobile station 60 and the SUPL server 20 will be described. When GNSS positioning is performed in the mobile station 60, it is necessary to provide a communication path between the mobile station 60 and the SUPL server 20 which transmits assist data for GNSS positioning to the mobile station 60. In order to do so, the mobile station 60 transmits a connection request for providing a communication path with the SUPL server 20, to the GW device 50 through the base station device 70. This connection request is transmitted through operation to the mobile station 60 by the user of the mobile station 60. The GW device 50 receives this connection request, and a TCP (Transmission Control Protocol) connection establishment process is performed between the mobile station 60 and the GW device 50 (S01). In addition, a TCP connection establishment process is performed between the GW device 50 and the SUPL server 20 (S02).

When the TCP connection establishment process is performed between the GW device 50 and the mobile station 60 (S01), information concerning the mobile station 60 that is transmitted from the mobile station 60 is transmitted to the user information management device 40. Here, the information transmitted to the user information management device 40 includes a source IP address of the mobile station 60, a source port number, SGSN IP address, and roaming area information. These pieces of information are also transmitted to the SUPL server 20 during the TCP connection establishment. Upon receiving these pieces of information from the GW device 50, the user information management device 40 updates the user information stored in the user information management device 40 based on these pieces of information (S04). Accordingly, the roaming area information (MCC, MNC, and cell ID) concerning the cell C1 in which the mobile station 60 is present and the information concerning the IP address of the SGSN controlling the base station device 70 related to the cell C1 are stored into the user information management device 40.

Then, a process of establishing a TLS (Transport Layer Security) tunnel to be used in transmission/reception of information concerning positioning is performed between the mobile station 60 and the SUPL server 20 through the TCP connection created through the process above (S05). As a result of the process above, a communication path for performing communication for positioning between the mobile station 60 and the SUPL server 20 is provided, and the preparation concerning transmission/reception of information is completed.

Next, referring to FIG. 8, an authentication process concerning positioning in the mobile station 60 is described. When the TLS tunnel is established (S05) through the process above, a positioning start request (ULP_SUPL-START) is transmitted from the mobile station 60 to the SUPL server 20 (S11, an approximate location information transmission step). Here, the positioning start request transmitted from the mobile station 60 to the SUPL server 20 includes a session ID (identifier commonly allocated to a process concerning GNSS positioning at a time), a mobile station function indicating the positioning ability of the mobile station 60 (information indicating a mobile station function), roaming area information, accuracy of positioning by the mobile station 60, and a state of connection to the cell C1 by the mobile station 60. An MSISDN (Mobile Subscriber ISDN Number) of the mobile station 60 is further included as information that specifies the mobile station 60. Upon receiving the positioning start request, the communication unit 21 of the SUPL server 20 requests an authentication process for the mobile station 60 (HTTP_Authentication-Request) from the location information management device 30 (S12). This request includes a session ID, roaming area information, the MSISDN of the mobile station 60, a source IP address, and a source port number.

Upon receiving this request from the SUPL server 20, the communication unit 31 of the location information management device makes an inquiry about user information (ISCP_Authentication-Request) by transmitting the MSISDN of the mobile station 60 to the user information management device 40 in order to verify the user information (S13). Upon receiving the MSISDN of the mobile station 60, the user information management device 40 calls up the user information by reading out the user's profile (S14). The information concerning the user of the mobile station 60 is transmitted from the GW device 50 to the user information management device 40 and updated in advance (S04). Therefore, in the user information management device 40, this information (the source IP address, the source port number, the roaming area information, the SGSN IP address) is acquired and transmitted as a user information response (ISCP_Authentication-Response) to the location information management device 30 (S15). In the location information management device 30, when the information transmitted from the user information management device 40 is received, the received information is transmitted from the communication unit 31 to the control unit 32 together with the information previously transmitted from the SUPL server 20. Then, the control unit 32 confirms whether both pieces of information agree to determine whether communication between the mobile station 60 and the SUPL server 20 can be continued (S16). Here, if the information does not agree, it is determined that communication with the mobile station 60 cannot be continued, and the connection is terminated. If it is determined that communication can be continued, the process proceeds to the process concerning approximate location information transmission.

As a process concerning decision of information to be transmitted as approximate location information to the mobile station 60, first, information (transmission data) to be transmitted from the location information management device 30 to the SUPL server 20 is decided in the control unit 32 (S17, an approximate location information acquisition step). An instruction (HTTP_Authentication-Response) is given to indicate that the authentication process is completed and to make preparation for output of the approximate location information, by transmitting the determined transmission data from the communication unit 31 to the SUPL server 20 (S18, the approximate location information acquisition step). The instruction transmitted from the location information management device 30 to the SUPL server 20 includes a session ID, an authentication result, location information acquired in the location information management device 30, roaming area information, and the IP address of the SGSN.

Here, as a process performed in the control unit 32 of the location information management device 30, first, it is determined whether an inquiry can be made to another network provider, based on the roaming area information of the information transmitted from the mobile station 60 through the SUPL server 20 and the information stored in the management DB 33. This is determined based on whether a flag indicating “an inquiry to the GMLC is possible” is set for the operator specified with the MCC and the MNC included in the roaming area information, in the information stored in the management DB 33.

If it is determined that an inquiry to the GMCL is possible, the communication unit 31 of the location information management device 30 requests provision of location information (Lr-IF SRLIR) using the cell ID from the GMCL of the operator, whereby the location information (altitude, longitude, and error information) of the base station device 70 specified with the cell ID is acquired (Lr-IF SRLIA) (the approximate location information acquisition step). Then, the resultant location information of the base station device 70 is transmitted from the communication unit 31 to the SUPL server 20 (S18). Here, information indicating that transmission data is acquired by making an inquiry to the GMLC of another network (the mobile communication network N2) is transmitted in association with the transmission data transmitted from the communication unit 31 to the SUPL server 20.

When the location information of the base station device 70 is transmitted as transmission data from the location information management device 30 to the SUPL server 20, a flag indicating that “the information stored in the approximate location information DB 23 is not used as approximate location information” is given in association with that information. This aims to give an instruction to use the information of the base station device 70 acquired by making an inquiry to the GMLC by highest priority because this information is the most precise.

When a flag indicating “an inquiry to the GMLC is impossible” is given, the precise location information of the base station device 70 corresponding to the cell ID cannot be acquired, so that one of the location information of the SGSN stored in the location information management device 30 and the location information derived from the MCC and the MNC is selected and transmitted from the communication unit 31 to the SUPL server 20 without making an inquiry about the location information of the base station device 70 to the GMLC of the mobile communication network N2. Here, the case where the location information of the base station device 70 is acquired and transmitted to the SUPL server 20 is described.

In the communication unit 21 of the SUPL server 20, when an instruction concerning preparation of approximate location information is received together with the transmission data, these pieces of information are sent to the control unit 22, and a process concerning preparation of approximate location information to be given to the mobile station 60 is performed (S19, an error radius update step). Specifically, in the control unit 22, it is determined whether the location information of the base station device 70 can be transmitted as it is as approximate location information to the mobile station 60 by referring to the location information of the base station device 70 that is included in the transmission data transmitted from the location information management device 30, and by comparing the location information with the information stored in the approximate location information DB.

The detailed process concerning update of error radius information will be described with reference to the flowchart in FIG. 9.

In the control unit 22 of the SUPL server 20, when the approximate location information is received (S101), a notification of the cell ID included in this approximate location information is given (S102). It is confirmed whether the approximate location information related to the cell corresponding to the cell ID is stored in the approximate location information DB 23. Here, if the approximate location information is stored, an error radius is acquired from the approximate location information. When the approximate location information is stored in the approximate location information DB 23, this approximate location information is the one that was updated in the past based on the positioning result by the mobile station 60, and is here referred to as the learned error radius. In the control unit 22, the learned error radius is acquired from the approximate location information DB 23 (S103). If the approximate location information related to the cell corresponding to the cell ID is not stored in the approximate location information DB 23, the subsequent process is not performed, that is, updating of the error radius (S19) is not performed.

Next, in the control unit 22, it is determined whether the learned error radius is smaller than the error radius by comparing the learned error radius acquired from the approximate location information DB 23 with the approximate location information transmitted from the location information management device 30 (the approximate location information acquired from the GMLC of the mobile communication network N2) (S104). Here, if the error radius in the approximate location information provided from the mobile communication network N2 is smaller than the learned error radius, it is determined in the control unit 22 that the mobile station 60 is likely to fall out of the communication area (cell C1) specified with the approximate location information, and it is decided to use the learned error radius stored in the approximate location information DB 23 as error radius information to be transmitted to the mobile station 60 (S105). On the other hand, if the error radius in the approximate location information provided from the mobile communication network N2 is equal to or larger than the learned error radius, it is determined in the control unit 22 that the mobile station 60 is less likely to fall out of the communication area (cell C1) specified with the approximate location information, and it is decided to use the error radius included in the approximate location information provided from the mobile communication network N2 as it is (S106). In this manner, in the control unit 22, for the purpose of providing more precise error radius information to the mobile station 60, information to be used as error radius information is decided by comparing the learned error radius information stored in the approximate location information DB 23 with the error radius information included in the approximate location information provided from the mobile communication network N2, and the approximate location information including this information is transmitted as assist data to the mobile station 60 (S107).

When the transmission data transmitted from the location information management device 30 is not the location information of the base station device 70 as described above but is the location information of the SGSN or information calculated from the MCC-MNC, the control unit 22 of the SUPL server 20 uses the information stored in the approximate location information DB 23 as information to be transmitted to the mobile station 60 or transmits the information transmitted from the location information management device 30 as it is to the mobile station 60. A description of the process in this case is omitted in the present embodiment because no determination is made as to whether to update the error radius information included in the approximate location information transmitted from the SUPL server 20.

After preparation of the approximate location information to be transmitted to the mobile station 60 is performed in the control unit 22 of the SUPL server 20 through the process above, a positioning start response (ULP_SUPL-RESPONSE) to the positioning start request (S11) is transmitted from the communication unit 21 to the mobile station 60 (S106, S20). The positioning start response here includes a session ID and information indicating a positioning system (“SET-Based-A-GNSS” specifying a network-assisted system).

Referring now to FIG. 10, a process concerning GNSS positioning in the mobile station 60 and a process after the positioning is described. The mobile station 60 transmits a request for provision of assist data (ULP_SUPL-POS-INT) including the approximate location information to the SUPL server 20 based on the positioning system (network-assisted system) designated in the positioning start response (S20) from the SUPL server 20 (S21). This request for provision includes a session ID, roaming area information, and information of the positioning performance of the mobile station 60 (the performance concerning the function used during network-assisted positioning).

In the communication unit 21 of the SUPL server 20, when the approximate location information provision request from the mobile station 60 is received, a notification is given to the control unit 22, and the control unit 22 acquires the approximate location information to be transmitted to the mobile station 60 (S22, the approximate location information transmission step). Here, a process for transmitting to the mobile station 60 the information to be transmitted to the mobile station 60 that is decided in the notification information output preparation (S19) (specifically, a process of storing the information in a SUPL_POS message) is performed. Then, a response (ULP_SUPL-POS (RRLP_Measure-Position-Request) including the approximate location information together with navigation information of GNSS satellites that is acquired through a process different from the process above is transmitted to the mobile station 60 (S23, the approximate location information transmission step). Here, a session ID, approximate location information (latitude, longitude, and error radius) as assist data, and navigation information of GNSS satellites (ephemeris, almanac) are transmitted to the mobile station 60.

Then, GNSS positioning is performed based on these pieces of information (S24) in the mobile station 60, and the location of the mobile station 60 is calculated by performing computation in the mobile station 60. Then, the positioning result information (ULP_SUPL-POS (RRLP_Measure-Position-Response) is transmitted from the mobile station 60 to the SUPL server 20 and received by the communication unit 21 of the SUPL server 20 (S25, a positioning result reception step). Here, the positioning result information transmitted from the mobile station 60 to the SUPL server 20 includes a session ID, a cell ID, a positioning result (altitude, longitude, error radius), and the number of satellites captured by the mobile station 60.

Then, in the SUPL server 20, the control unit 22 updates the approximate location information stored in the approximate location information DB 23 based on the positioning result transmitted from the mobile station 60 (S26, an approximate location information update step). Here, if the approximate location information associated with the cell ID has not yet been stored in the approximate location information DB 23, the positioning result by the mobile station 60 is newly stored as approximate location information. When the approximate location information stored in the approximate location information DB 23 is transmitted to the mobile station 60, the approximate location information is updated based on the approximate location information transmitted to the mobile station 60 and the result transmitted from the mobile station 60 after positioning, as described above.

Thereafter, a notification (ULP_SUPL-END) indicating that a series of processing concerning positioning is completed is transmitted from the communication unit 21 of the SUPL server 20 to the mobile station 60 (S27). Thus, the process concerning positioning by the mobile station 60 ends.

When the mobile station 60 performs GNSS positioning (S24), if GNSS positioning cannot be performed, for example, for the reason that assist data is inappropriate, GNSS positioning can be performed again by transmitting an additional request for assist data to the SUPL server 20 and receiving new assist data. If positioning is failed, for example, for the reason that a signal from a GNSS satellite cannot be suitably received, the process concerning positioning may be terminated by giving a notification to the mobile station 60 to indicate that positioning is failed.

When the mobile station 60 fails in GNSS positioning, GNSS positioning may be performed again after a series of processing concerning GNSS positioning as described above, by transmitting an additional request for assist data to the SUPL server 20 and receiving new assist data.

### <Effects by Positioning Support System and Positioning Support Method>

With the positioning method (positioning support method) by the positioning support system 10 and the positioning system 1 including the positioning support system 10 according to the foregoing embodiment, it is determined in the SUPL server 20 whether the error radius included in the location information (approximate location information) of the base station device 70 acquired from the mobile communication network N2 that is another communication network falls within a prescribed range. If out of the prescribed range, the error radius is updated to a predetermined value, and approximate location information including the updated error radius information is thereafter transmitted to the mobile station 60 for positioning computation. This makes it possible to provide approximate location information including more appropriate error radius information for positioning computation.

According to the foregoing embodiment, the learned error radius information included in the approximate location information held in the approximate location information DB 23 and updated in accordance with the past positioning result can be used to update error radius information to be transmitted to the mobile station 60. This makes it possible to provide approximate location information including more appropriate error radius information in accordance with the past positioning result.

According to the foregoing embodiment, whether update of error radius information is required is determined based on whether the error radius information included in the location information of the base station device 70 that is provided from the mobile communication network N2 is larger than the learned error radius held in the approximate location information DB 23. As a result, if update is required, the error radius information is updated using the learned error radius as a new error radius. Therefore, the learned error radius updated based on the past positioning result can be used effectively to provide approximate location information including more appropriate error radius information.

### <Other Methods Concerning Update of Error Radius Information>

Another method of performing update of an error radius (S19) is described now. In the error radius updating method in the foregoing description, the learned error radius stored in the approximate location information DB 23 of the SUPL server 20 is used. However, without using the learned error radius, whether to transmit the error radius acquired from the GMLC of the mobile communication network N2 as assist data may be determined in the control unit 22. In this case, update of approximate location information based on the past positioning result is not always required.

Specifically, it is determined in advance whether the cell C1 in which the mobile station 60 is present is an indoor station or an outdoor station, from the past positioning result in the same cell. Here, the outdoor station refers to a communication area configured with a base station device provided outside a building. In the case of this communication area, GNSS positioning using satellites is presumably easy because most mobile stations are used outdoors. On the other hand, the indoor station refers to a communication area configured with a base station device provided at a place where outdoor radio waves hardly reach, for example, inside a building or underground. In this case, the size of the communication area is presumably small when compared with the outdoor station. It can also be estimated that the possibility of success of GNSS positioning using satellites is low when compared with the outdoor station. In the control unit 22 of the SUPL server 20, it is estimated whether the cell C1 is an indoor station or an outdoor station based on the past positioning result, and a possible error radius is preset from each of the size of the cell estimated when cell C1 is determined as an indoor station and the size of the cell estimated when cell C1 is determined as an outdoor station. Then, when the location information of the base station device 70 is acquired as approximate location information from the mobile communication network N2, it is determined whether the error radius included in that location information is appropriate (whether to update the error radius).

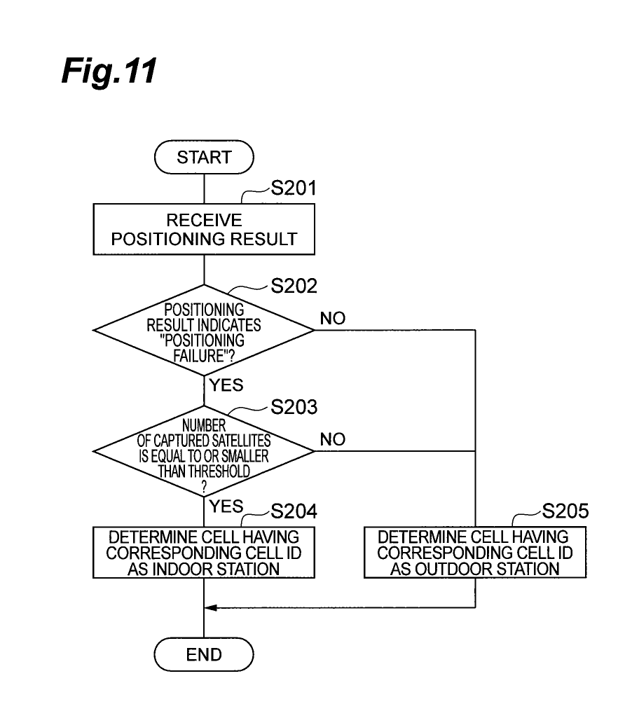

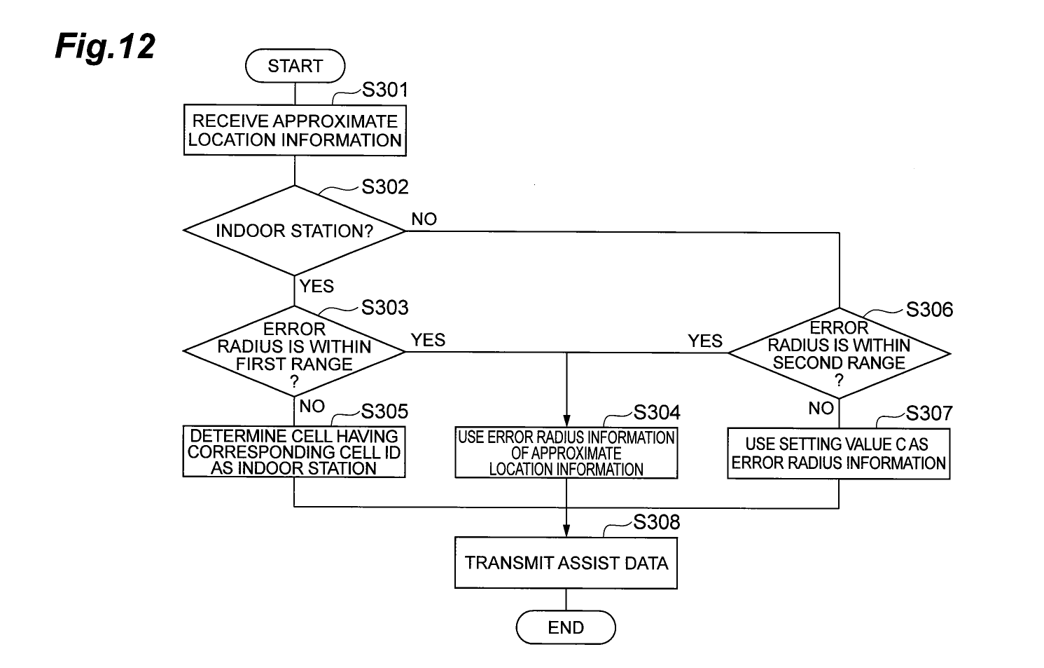

Referring to FIG. 11 and FIG. 12, a description will be given below in more details. FIG. 11 is a flowchart illustrating a method of determining an indoor station or an outdoor station based on the past positioning result. FIG. 12 is a flowchart illustrating a method of determining whether to update the error radius when the location information of the base station device 70 is acquired from the mobile communication network N2.

The process shown in FIG. 11 is performed during update of approximate location information (S26) after the positioning result is received from the mobile station 60 (S25 in FIG. 10). First, the positioning result is received in the control unit 22 of the SUPL server 20 (S201). This positioning result includes the cell ID specifying the cell C1, a positioning result, and the number of satellites captured by the mobile station 60. Then, in the control unit 22, it is determined whether the positioning result indicates “positioning failure” (S202).

Here, if the positioning failure result is obtained, it is determined whether the number of satellites captured by the mobile station 60 during positioning is equal to or smaller than a threshold (for example, two) (S203). If the positioning by the mobile station 60 is failed and if the number of satellites captured is small, it can be estimated that the mobile station 60 is in the indoors, so that it is determined that the cell C1 in which the mobile station 60 is present is in the indoors and that the base station device 70 is an indoor station (S204). If the positioning by the mobile station 60 is successful or if the number of satellites captured by the mobile station 60 is greater than the threshold, it is estimated that the mobile station 60 is in the outdoors, so that it is determined that C1 in which the mobile station 60 is present is in the outdoors and that the base station device 70 is an outdoor station (S205). Through such a process, it is determined in advance whether the cell specified with the cell ID is an outdoor station or an indoor station. In this case, the determination result is held in the control unit 22 in association with the cell ID. The determination result may be updated based on a plurality of positioning results.

Next, a description will be given of the determination as to whether update of error radius information is required in the control unit 22 when the location information of the base station device 70 that constitutes the cell C1 is transmitted from the GMLC of the mobile communication network N2 to the location information management device 30, and this information is sent to the SUPL server 20, when the mobile station 60 performs positioning.

As a precondition, the control unit 22 holds a determination criterion that an error radius is appropriately set when the error radius is included in a range (first range) from a value A (lower limit value) to a value B (an upper limit value) for an indoor station, or when the error radius is included in a range (second range) from a value C (lower limit value) to a value D (upper limit value) for an outdoor station. The first range and the second range may partially overlap each other or may be provided completely differently.

In the control unit 22 of the SUPL server 20, when the approximate location information (the location information of the base station device 70) transmitted from the location information management device 30 is received (S301), it is determined whether this base station device 70 is an indoor station (S302). This determination is made based on whether the control unit 22 holds the result of determination of an indoor station or an outdoor station in conjunction with the cell ID of the base station device 70. Here, if it is determined as an indoor station, then it is determined whether the error radius included in the location information of this base station device 70 is included in the first range corresponding to an indoor station (S303). Here, if the error radius provided as the location information of the base station device 70 falls within the first range, it is determined that the provided error radius has an appropriate value, and this error radius information is used as it is (S304). If the error radius does not fall within the first range, it is determined that a value different from an appropriate error radius is provided as location information, and it is decided that the value A is to be used as new error radius information (S305).

If it is determined that the base station device 70 is an outdoor station, then it is determined whether the error radius included in the location information of the base station device 70 is included in the second range corresponding to an outdoor station (S306). Here, if the error radius provided as the location information of the base station device 70 falls within the second range, it is determined that the provided error radius has an appropriate value, and this error radius information is used as it is (S304). If the error radius does not fall within the second range, it is determined that a value different from an appropriate error radius is provided as location information, and it is decided to use the value C as new error radius information (S307).

Through the process above, whether update of the error radius included in the location information of the base station device 70 is required is determined by the control unit 22. If update is required, the error radius is updated, and thereafter the updated approximate location information is transmitted as assist data to the mobile station 60 (S308).

In this manner, even when information concerning the learned error radius is not included in the approximate location information DB, whether update of the error radius provided from the mobile communication network N2 is required can be determined by setting and holding a range estimated as an appropriate error radius in the control unit 22 in advance and by comparing the held range with the error radius included in the location information of the base station device 70 that is provided form the mobile communication network N2.

With the method above, the SUPL server 20 acquires the positioning result information resulting from transmission of approximate location information, and a numerical range for determining whether update of error radius information is required is decided based on the positioning computation result in the mobile station 60, so that a numerical range of more appropriate error radius is selected as a criterion for determining whether update is necessary. As a result, it becomes possible to provide approximate location information including more appropriate error radius information.

Furthermore, as in the method above, two kinds of numerical ranges, namely, the first range and the second range different from each other, are held in advance, and whether update of the error radius is required is determined by selecting from the two kinds of numerical ranges depending on whether the positioning concerning the mobile station 60 is successful, and the number of satellites captured by the mobile station 60. Accordingly, it becomes possible to provide approximate location information including more appropriate error radius information.

Although the determination as to whether update of the error radius is required is made using the two kinds of numerical ranges, namely, the first range and the second range in the foregoing description, only one kind of numerical range may be held, and the determination as to whether update is required can be made uniformly using the same numerical range. In another manner, three or more kinds of numerical ranges may be held and used in the determination as to whether update is required.

As for which numerical range is used to determine whether update of the error radius is required, it is possible to use a method different from the method using evaluation based on whether the positioning is successful and the number of satellites captured by the mobile station 60 as described above. For example, when the SUPL server 20 receives the positioning information provision request from the mobile station 60 (S11 in FIG. 8), environmental information indicating the environment surrounding the mobile station 60 (the amount of ultraviolet radiation, the sun light intensity, and the like measured by the mobile station) is acquired, and whether the base station device to which the mobile station 60 connects is an outdoor station or an indoor station is determined based on whether the environmental information falls within a prescribed range. For example, a determination criterion may be set in such a manner that if the amount of ultraviolet radiation measured by the mobile station is greater than a prescribed value, the mobile station is in the outdoors, and the base station device to which the mobile station connects is also an outdoor station. Then, based on this criterion, it can be decided which numerical range is used to determine whether update of the error radius is required.

Although an embodiment of the present invention has been described above, the positioning system 1 including the positioning support system 10 according to the present invention is susceptible to various modifications.

For example, the functions concerning the SUPL server 20 and the location information management device 30 included in the positioning support system 10 may be included all in one device, or may be distributed over different devices. In the foregoing embodiment, the mobile station 60 performs GNSS positioning after acquiring assist data from the SUPL server 20, and then performs a positioning computation process of calculating the current location of the mobile station 60 from the positioning data. However, the positioning computation process of calculating the current location of the mobile station 60 may be performed by a device different from the mobile station 60.

In the description of the foregoing embodiment, a cell is used as a communication area in which the mobile station 60 is present. However, the communication area according to the present invention is not limited to a cell. For example, an area managed by an SGSN located upstream of a base station device managing a cell for performing control of packet communication (the area shown as an upper-level area in the present embodiment) may be regarded as the communication area, and an area containing areas managed by a plurality of SGSNs may be regarded as an upper-level area. Even in this case, similar positioning support as in the foregoing embodiment can be performed.

The method of updating approximate location information is not limited to the method described in the foregoing embodiment, and any other computation methods may be employed.

Furthermore, the method of updating the error radius of the approximate location information to be transmitted to the mobile station 60 is not limited to the foregoing method. For example, the description in the foregoing embodiment separately provides a manner in which the learned error radius information stored in the approximate location information DB 23 is used as a threshold, and the error radius is updated based on whether it falls in a range greater than the learned error radius, and a manner in which a prescribed range is set in advance without using the information stored in the approximate location information DB 23, and whether update of the error radius is required is determined based on whether the error radius of the approximate location information acquired from the mobile communication network N2 falls within the prescribed range. However, these methods may be combined to determine whether update of the error radius information included in the approximate location information is required. In another manner, the value of an error radius newly set when the error radius is updated may be acquired from another device every time whether update of the error radius is required is determined.

In the description of the foregoing embodiment, an error radius of a cell to which the mobile station connects is used as the error radius of the approximate location information to be transmitted to the mobile station 60. However, the approximate location of the mobile station and the error radius thereof based not on the information of the cell to which the mobile station connects but on different information may be used as the approximate location information provided from another communication network.

The description in the foregoing embodiment provides a manner in which the approximate location information stored in the approximate location information DB 23 is updated based on the positioning result information from the mobile station 60 to which approximate location information has been transmitted. However, it is not always necessary to use only the positioning result of the mobile station to which approximate location information has been transmitted, for update of the approximate location information. The information stored in the approximate location information DB 23 may also be updated based on the positioning result information obtained by performing positioning without transmitting approximate location information (for example, by the stand-alone system).

### REFERENCE SIGNS LIST

1 . . . positioning system, 10 . . . positioning support system, 20 . . . SUPL server, 30 . . . location information management device, 40 . . . user information management device, 50 . . . GW device, 60 . . . mobile station, 70 . . . base station device, C1 . . . cell, N1, N2 . . . mobile communication network.

1. A positioning support device that is used for positioning computation when a mobile station in another communication network different from the network of the carrier of the mobile station captures satellites and performs positioning using information from the satellites, and that transmits approximate location information including error radius information that is information indicating an error radius of an area in which the mobile station is located, the positioning support device comprising:
an approximate location information acquisition unit for acquiring the approximate location information from the other communication network;
an error radius information update unit for updating the error radius information included in the approximate location information acquired by the approximate location information acquisition unit; and
an approximate location information transmission unit for transmitting the approximate location information updated by the error radius information update unit, wherein
the error radius information update unit determines whether the error radius falls within a prescribed range, and, if the error radius falls out of the prescribed range, updates the error radius information with a value different from the error radius specified with the error radius information as a new error radius.

2. The positioning support device according to claim 1 further comprising:
a positioning result reception unit for receiving positioning result information that is information transmitted from a destination to which the approximate location information is transmitted by the approximate location information transmission unit and indicating a result of the positioning computation, wherein
the error radius information update unit decides a numerical range for determining whether update of the error radius information is required, based on the positioning result information received by the positioning result reception unit.

3. The positioning support device according to claim 2, wherein
the positioning result information includes information indicating whether the positioning by the mobile station is successful and information indicating the number of satellites captured by the mobile station,
the error radius information update unit holds a prescribed first range and a prescribed second range having a value smaller than the first range, in advance,
when the positioning by the mobile station is successful or when the number of satellites captured by the mobile station is equal to or greater than a prescribed number, whether update is required is determined based on whether the error radius of the communication area is included in the first range, and
when the positioning by the mobile station is failed and when the number of satellites captured by the mobile station is smaller than the prescribed number, whether update is required is determined based on whether the error radius of the communication area is included in the second range.

4. The positioning support device according to any one of claims 1 to 3 further comprising:
environmental information reception unit for receiving environmental information indicating an environment surrounding the mobile station, wherein
based on a range corresponding to the environmental information received by the environmental information reception unit, the error radius information update unit determines whether the error radius falls within the range.

5. The positioning support device according to claim 1 further comprising:
an approximate location information storage unit for storing the approximate location information;
a positioning result reception unit for receiving positioning result information that is information transmitted from a destination to which the approximate location information is transmitted by the approximate location information transmission unit and indicating a result of the positioning computation; and
an approximate location information update unit for updating error radius information included in the approximate location information stored in the approximate location information storage unit, based on the positioning result information, and for setting the updated error radius information as learned error radius information, wherein
the error radius information update unit sets the prescribed range based on the learned error radius information.

6. The positioning support device according to claim 1, wherein
the error radius information update unit determines whether an error radius specified with the error radius information included in the approximate location information acquired by the approximate location information acquisition unit is greater than a learned error radius specified with the learned error radius information updated by the approximate location information update unit, and, if the error radius is smaller than the learned error radius, updates the error radius information with the learned error radius as a new error radius in place of the error radius specified with the error radius information.

7. A positioning support method performed by a positioning support device that is used for positioning computation when a mobile station in another communication network different from the network of the carrier of the mobile station captures satellites and performs positioning using information from the satellites, and that transmits approximate location information including error radius information that is information indicating an error radius of an area in which the mobile station is located, the positioning support method comprising:
an approximate location information acquisition step of using an approximate location information acquisition unit to acquire the approximate location information from the other communication network;
an error radius information update step of using an error radius information update unit to update the error radius information included in the approximate location information acquired in the approximate location information acquisition step; and
an approximate location information transmission step of using an approximate location information transmission unit to transmit the approximate location information updated in the error radius information update step, wherein
in the error radius information update step, whether the error radius falls within a prescribed range is determined, and, if the error radius falls out of the prescribed range, the error radius information is updated with a value different from the error radius specified with the error radius information as a new error radius.
